(19) United States
(12) Patent Application Publication
(10) Pub. No.: US 2012/0240098 A1
(43) Pub. Date: Sep. 20, 2012

(54) Software Development and Publishing Platform

(75) Inventors: Neil Souza, San Francisco, CA (US); Anthony Alexander Espinoza, Palo Alto, CA (US)

(73) Assignee: Viacom International, Inc., New York, NY (US)

(21) Appl. No.: 13/051,171

(22) Filed: Mar. 18, 2011

(51) Int. Cl. G06F 9/44

(52) U.S. Cl. 717/104

(57) ABSTRACT

Described are methods, systems, and computer program products for providing a flexible development platform. The system aspect includes a hierarchical data modeling system, which itself includes a number of data modeling system base data types, a structure class comprising one or more complex data types. There is also an encoding module. In the first structure class, each complex data type includes the data modeling system base data types or another structure class. The encoding module converts the one or more complex data types of the first structure class into a form using only the data modeling system base types.

### FIELD OF THE INVENTION

The present invention relates to software application development platforms, and, more specifically, to a platform for game development that allows developers to create complex data types using a set of base types and persisting those complex data types to a variety of data storage devices without configuration by the developer.

### BACKGROUND

Many of today's popular games are delivered over the Internet, specifically the World Wide Web. And these games are not just online versions of classic board games like tic-tac-toe or Scrabble; they are complex, dynamic, and persistent. Some examples of these include Neopets®, which lets users create and take care of virtual pets; Runescape, a fantasy massively multiplayer role playing game; and FarmVille, a game accessed through the social networking site Facebook, that lets players manage a virtual farm.

One downside of online games in general, including web-based games, is that they are developed typically to utilize a specific computer architecture. That is, they rely on custom-developed data types to store game data and then store that data using transport and data storing mechanisms that are hard-coded and fixed. If the developer wants to move from one storage mechanism to another storage mechanism, e.g., from a SQL-based database to a YAML document store, he must rewrite the persistence layer of his application. Further, if the new storage mechanism does not support the data types of the game, the developer must rewrite his game to use data types supported by the storage mechanism. This makes it difficult to port games using one architecture to another architecture.

### SUMMARY OF THE INVENTION

The current invention provides a development and publishing architecture that provides a set of base data types that can be used to create complex data types, and provides an intelligent means of transporting and storing data, regardless of the target data repository. Beneficially this allows developers to first, quickly build a game using base types, including creating new data types using the base types and allows the game data to be transported and persisted to different storage formats with little to no modification of the code by the game developer. The game development and publishing platform described herein will be referred to as “Catapult.”

In one aspect, the invention is a method for providing a flexible development platform. The method involves providing a hierarchical data modeling system to a computer program developer, the hierarchical data modeling system including a plurality of data modeling system base data types and programming means to create one or more complex data types, each complex data type comprising the data modeling system base data types or a first structure class. The method also includes receiving, by a computer program language processor, a second structure class comprising one or more complex data types. A computer program language processor then inspects the structure class during pre-processing, and creates a reference to the one or more complex data types. Then, the one or more complex data types of the second structure class are encoded using the reference into a form expressed as the data modeling system base types. Then, the computer program language processor defines a relationship between the plurality of data modeling system base data types and a plurality of storage device base data types. Finally, the first structure class is stored in a storage device by storing the data modeling system base types of the encoded one or more complex data types in the storage device using the defined relationships.

There is also a system for providing a flexible development platform. The system includes a hierarchical data modeling system, which itself includes a number of data modeling system base data types, a structure class comprising one or more complex data types. There is also an encoding module. In the first structure class, each complex data type includes the data modeling system base data types or another structure class. The encoding module converts the one or more complex data types of the first structure class into a form using only the data modeling system base types.

There is also a computer program product, tangibly embodied in a non-transient computer-readable storage medium, e.g., on a disk, CD, DVD, on a hard drive, etc., for providing a flexible development platform. The computer program product includes instructions that are operable to cause a data processing apparatus, e.g., a computer, to provide a hierarchical data modeling system. The hierarchical data modeling system includes a number of data modeling system base data types, and a structure class that has one or more complex data types. Each complex data type includes the data modeling system base data types or a second structure class. There is also an encoding module provided to convert the one or more complex data types of a structure class into a form using only the data modeling system base types.

Any of the above aspects enjoy the following benefits. There can also be a first storage device, such as a database or a document datastore, that has a number of storage device base data types. In these embodiments, there is also a mapping that defines a relationship between the storage device base data types and the data modeling system base data types. There is also a first module for storing the first structure class to the first storage device by storing the data modeling system base types of the encoded complex data types in the first storage device using the storage device base data types based on the first mapping.

In some implementations of the above aspects, the first storage device can be replaced with a second storage device that has its own storage device base types (and can be a completely different type of storage device). In these implementations, the first mapping can be replaced with a second mapping that defines a relationship between the storage device base data types of the second storage device and the data modeling system base data types. Additionally, the first module can be replaced by a second module for persisting the first structure class to the second storage device by storing the data modeling system base types of the encoded complex data types in the second storage device using the storage device base data types of the second storage device, based on the second mapping. Beneficially, replacing the first storage device and the first module with the second storage device and second module do not alter the structure class.

In some embodiments, there is also a framework configured to allow a developer to define the structure class and the complex data types, but does not allow the developer to define the data modeling system base data types

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1A shows a user data record in a data store;

FIG. 1B shows the User class with attributes that correspond to the columns in the database table;

FIG. 2 shows a GeoPt class;

FIG. 3 shows a fixed set of base types is defined in one implementation of Catapult;

FIG. 4 shows that each Property in Catapult has a base type as a class attribute, and provides functions to convert its values to and from that base type;

FIG. 5 shows an example of how Catapult benefits a developer by having complex types be expressed as base types;

FIG. 6 shows data similar to that shown in FIG. 1A;

FIG. 7 shows a model class in the application code used to wrap the data records shown in FIG. 6;

FIG. 8 illustrates an example of a database record where an energy property is added to the User record;

FIG. 9 shows another way of expressing the energy property in another, more-hierarchical data store like YAML;

FIG. 10 shows one potential implementation of a User class that maps to the flattened database schema of FIG. 8;

FIG. 11 shows an Energy class unto itself that extends the Object class, and has current, min, and max as IntegerProperties;

FIG. 12 shows an Energy class that extends Structure (rather than Object in FIG. 11), and is modular and re-usable across different models and within the same model;

FIG. 13 shows the various drivers available to conform the User Model to the various data storage and transport mechanisms; and

FIG. 14 depicts a flowchart for the process of converting complex types into base types.

### DETAILED DESCRIPTION

For every type of data record in a Catapult-based application (e.g., every piece of information stored in a database), there is a corresponding Model class in the development language provided to and used by a developer. Python is used herein as an example, but any programming language is usable, e.g., C, C++, Java, C#, and the like. The Catapult system provides a Model class and several base classes for developers to create their applications with. Each Model class and the base classes can be transported and persisted to the various data stores available to the Catapult system. Specifically, instances of the Model class are used to interact with data records of that type to retrieve and store data in the data stores. That is, the data records in a data store are accessed and manipulated by manipulating an instance of the Model class. For each field that a data record has, the Model class has a corresponding Property as a class attribute that represents that field. A Property is a generic class that can be extended to provide getters and setters and other functions for the attribute.

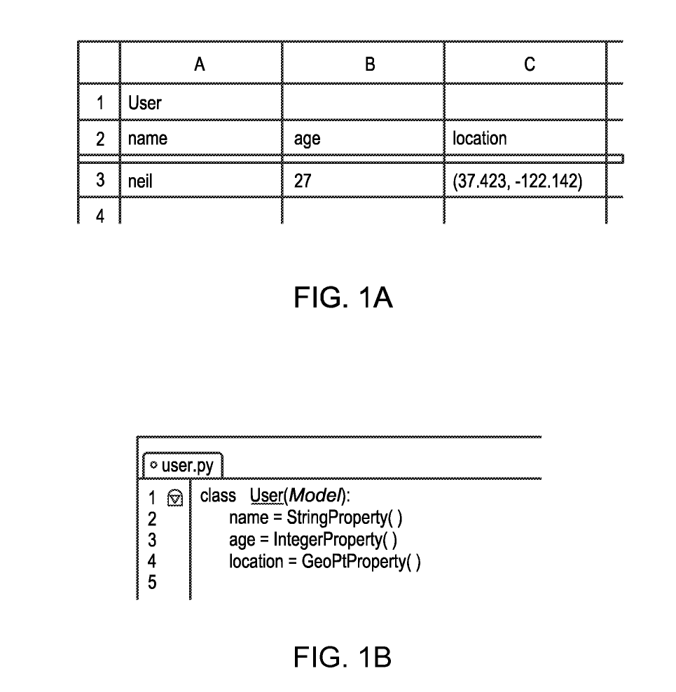

The Model class is extended to create custom classes used by a developer in his or her application. In the following examples, the User class provides an example of an implementation of the Model class. FIG. 1A shows a user data record in a data store. The user data record, here expressed as a typical database table with rows and columns, has a name field, an age field, and a location field. A row in the table exists for user “Neil,” who is 27 years old, and is located at geographical location 37.423, −122.142. The attributes in each column/row intersection are then accessed via Property classes, which are attributes of the User class. FIG. 1B shows the User class with attributes that correspond to the columns in the database table. For clarity's sake, in the example language used herein (Python), the class definition is expressed as “class <name of class>(<name of class this class is extending>).” So in FIG. 1B, the class User is extending the Model class.

In FIG. 1B, the User class has a name attribute, which is a StringProperty, an age attribute, which is an IntegerProperty, and a location attribute, which is a GeoPtProperty. These Property instances provide the fields as a string, integer and geographic point, respectively. Thus, when an instance of the User class is instantiated, the name attribute is a string and the age is an integer. The location, an instance of a GeoPtProperty class, provides a latitude attribute and a longitude attribute by way of reading and writing GeoPt instances to string base values.

This example illustrates a typical shortcoming of some development platforms. Specifically, most data storage solutions can store integer and string fields, but few have natively data structures for geographic points. And it is not a viable option to extend the type system in most storage solutions—databases typically use a fixed number of types, set by the database vendor—so a more practical solution is to store the geographic point as an encoded string, or a series of strings in different columns, and reconstruct the instance into a GeoPt object when retrieving records.

Continuing the GeoPt example, in prior art approaches, the software developer would create software components to store the object by converting the attributes of the GeoPt instances to strings or other data types that were native to the storage device when a “save” or “put” command was issued. Correspondingly, when a “load” or “get” command was issued, the developer would have created software logic to read the individual strings from the database to populate an instance of the GeoPt class. This approach breaks down though when the developer wants to port his code to a storage device that does not support the same data types that the one he is currently using. This would force him to re-architect his code to support the data types of the new storage mechanism.

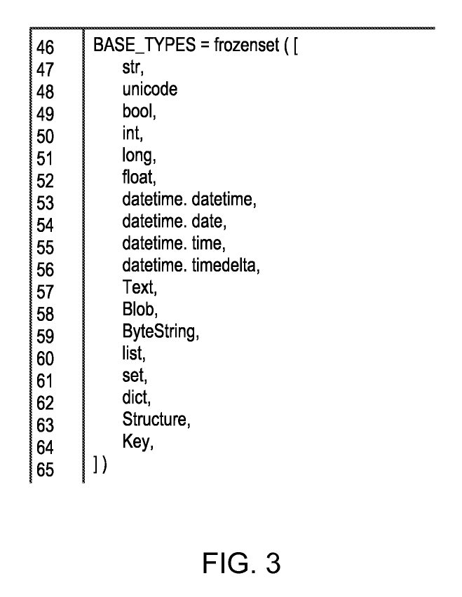

Catapult's base type system solves this problem. A fixed set of types called the ‘base types’ are defined in one implementation of Catapult, shown in FIG. 3. These base types are listed in Table 1 below, with a brief description of what they represent.

TABLE 1

| Type Name | Type Description |
|---|---|
| str | String |
| unicode | Unicode text |
| bool | Boolean |
| int | Integer |
| long | Long integer |
| float | Float value |
| datetime.datetime | Full date with time |
| datetime.date | Month/Day/Year (order is |
| | changeable) |
| datetime.time | Time of day |
| datetime.timedelta | Represents a length of time |
| Text | Text block |
| Blob | Binary Large Object |
| ByteString | String of bytes |
| List | A one-dimensional list |
| Set | An unordered collection of unique |
| | objects |
| Dict | A two dimensional list of ordered |
| | pairs |
| Structure | A super class (more on this below) |
| Key | A unique identifier |

Other base types could be used, and the invention is not limited to these—they are provided merely as an example of one implementation.

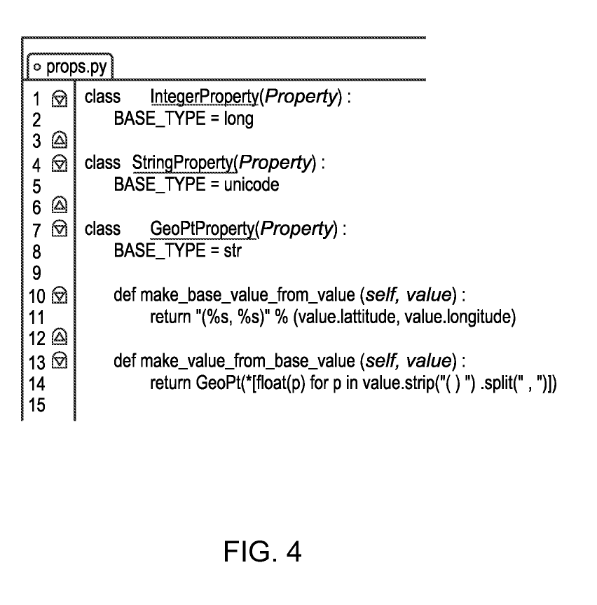

Each Property class in Catapult has a base type as a class attribute, and provides functions to convert the values represented by the Property class to and from that base type, as shown in FIG. 4. But the conversion functions are not always necessary. For example, the IntegerProperty and StringProperty classes, which both extend the Property class, do not have defined conversion functions because they correspond to base types defined above in Table 1, i.e., there is a direct translation from those classes into a base type built into Catapult. Specifically, all StringProperty instances are directly expressible as Unicode text, and all IntegerProperty instances are expressible as long integers.

When a Property class is more complex than a simple adoption of a base type above, functions for converting the Property class into and out of its BASE_TYPEs are created. In FIG. 4, a GeoPtProperty class is provided to wrap a GeoPt object.

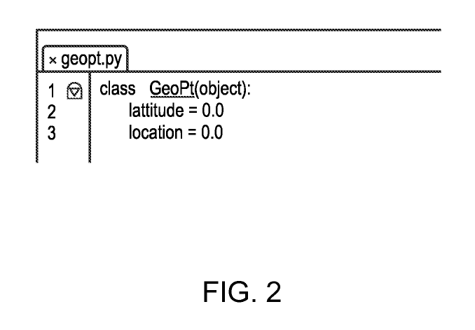

The BASE_TYPE of the GeoPtProperty class is a “str.” Since the latitude and longitude attributes of the GeoPt class in FIG. 2 do not readily correspond to a single string, conversion methods are necessary. Thus the GeoPtProperty's make_base_value_from_value function converts the latitude and longitude attributes of the value object passed into the function (an instance of a GeoPt object) into a string (the base type of the GeoPtProperty) of two values separated by a comma, e.g., “37.423, −122.142”. Correspondingly, GeoPtProperty also has a function, make_value_from_base_value, that returns a GeoPt instance based on an input string. Note, the GeoPtProperty and GeoPt classes do not have a two-way relationship. The GeoPt class does not have a relationship with or “know” about the GeoPtProperty class. It is the GeoPtProperty class's make_value_from_base_value function's return statement (which returns a GeoPt object) that established the relationship between the GeoPtProperty class and the GeoPt class. The GeoPtProperty class could instead return a two element array, or other object, which would establish a one-way relationship between the GeoPtProperty class and that object or data structure.

Thus, referring back to FIG. 1B, instances of Model classes such as the User class, which are made up of Property classes (and optionally base types), can be expressed in a form using just base types. Because the Catapult system provides converters to convert base types to the native types of a particular data store, expressing Models as base types allows the developer to transport and persist any data to any data store that Catapult has native types for. And existing applications can easily be ported to new data stores by simply creating data stores drivers that convert the base types to the native types of the new data store and the developer does not have to change his code at all.

The developer does not have to create every complex type (i.e., types that are not base types) for his or her application. Catapult provides a library of pre-defined complex types. As with any developer-created complex type, these complex types have functionality that allows the complex type to be expressed in the form of Catapult's base types.

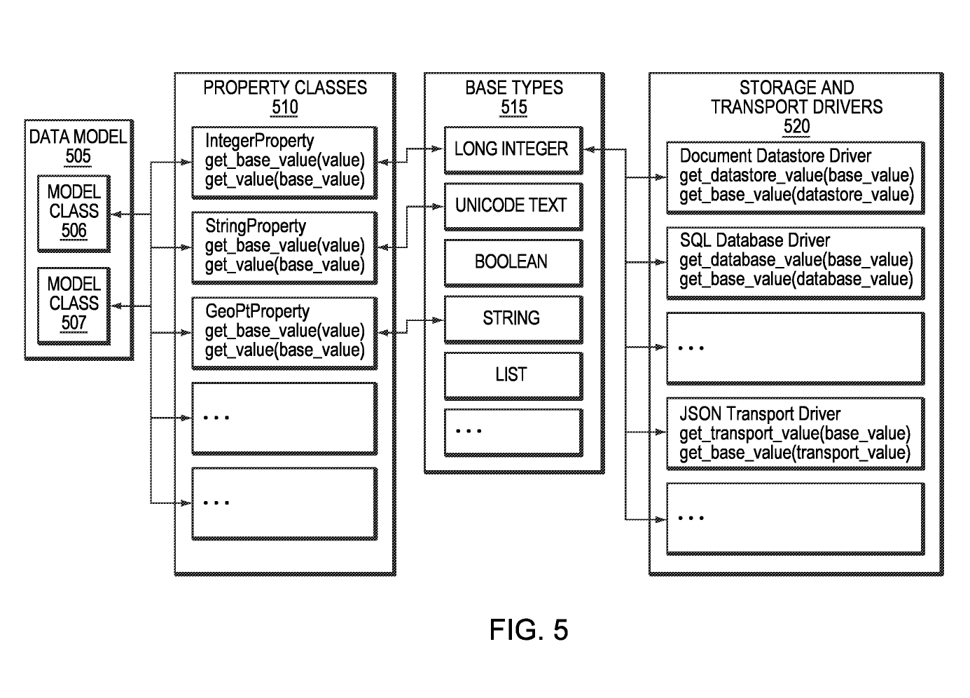

FIG. 5 shows an example of how Catapult benefits a developer by having complex types be expressed as base types. The Data Model 505 has various Model Classes 506, 507, which include various complex types (here Property Classes 510), e.g., IntegerProperty, StringProperty, and GeoPtProperty. Some are provided by Catapult, and some are defined by a developer. These Property classes are expressed using base types 515. Catapult then provides Storage and Transport Drivers 520 for various data stores and transport mechanisms, e.g., Document Data Store Drivers, SQL Database Drivers, and JSON Transport Drivers.

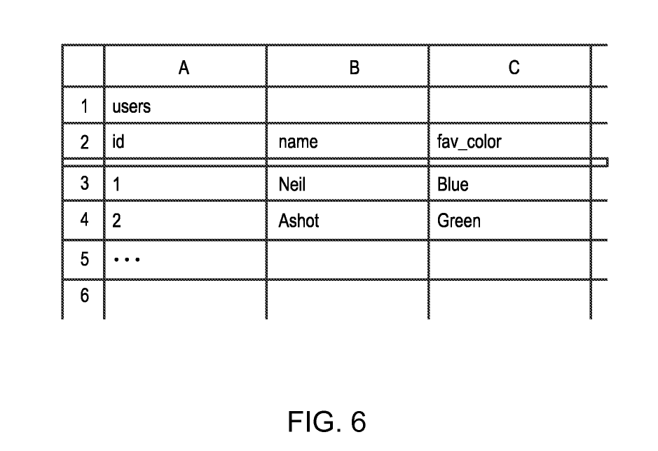

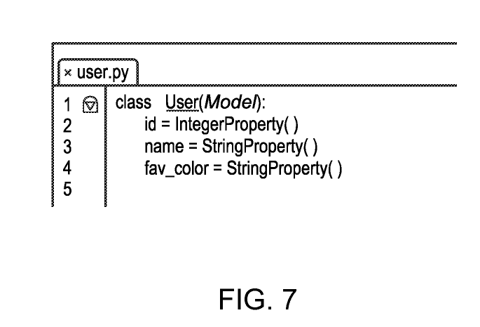

To illustrate another benefit of the Catapult system, FIG. 6 shows data similar to that shown in FIG. 1A. As discussed above, most web applications store their data in databases, which are essentially spreadsheets—each row represents one data record, with data values in each of the columns. Here, a user with id of “1” and a name of “Neil,” has a fav_color of “Blue.” Modern web application frameworks, such as Ruby on Rails (http://http://rubyonrails.org/), or Django (http://www.djangoproject.com/), create a model class in the application code to wrap the data records, as shown in FIG. 7. In FIG. 7, the User model class (which extends Model) correspondingly has an id attribute, a name attribute, and a fav_color attribute.

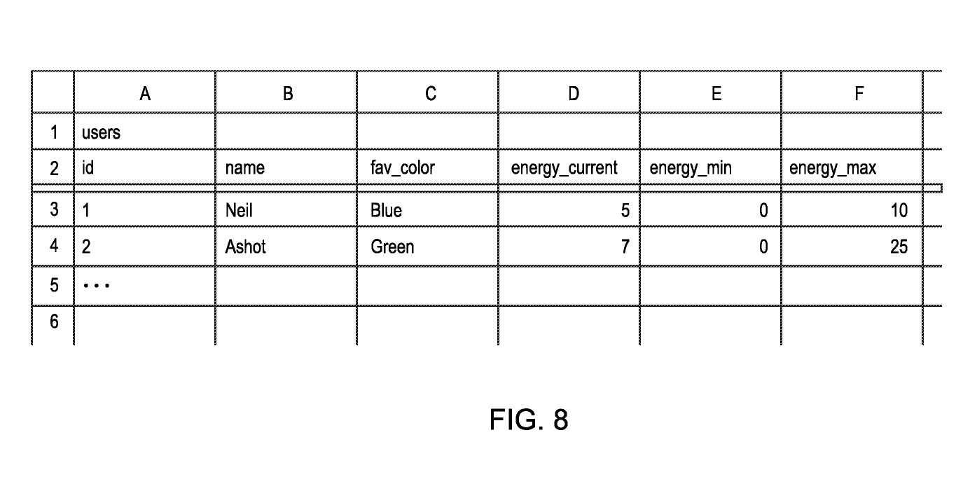

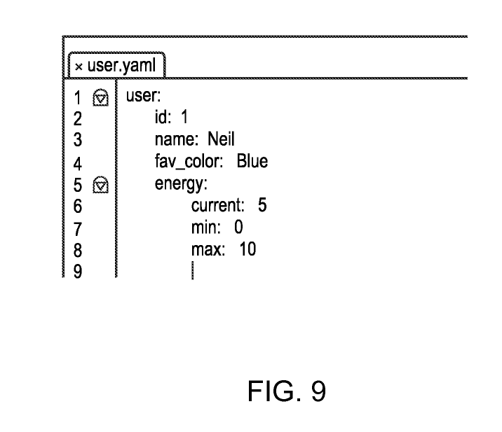

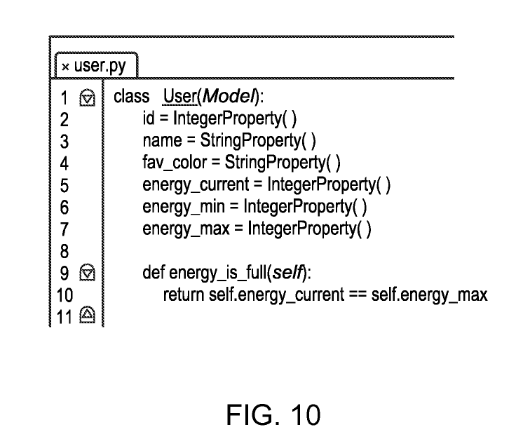

These model wrappers provide object-oriented access to the data structure in the application runtime. However, they are limited by the fact that the database is ‘flat’, while the natural representation of data records is often hierarchical. Take the example of adding an energy property to the User record, which has attributes of current, max and min. A database representation of this is shown in FIG. 8, where the database entries in FIG. 6 have additional columns corresponding to the new energy property, i.e., energy_current, energy_min, and energy_max. The naming convention in FIG. 8 requires some human intuition to understand that current, min, and max are properties of the energy attribute since all of the entries are at the same hierarchical level. Another way of expressing the energy property in another, more-hierarchical data store like YAML, is shown in FIG. 9. Here, the additional indentation of current, min, and max indicates to the reader and the YAML parser that these attributes are part of the energy property. When saving something hierarchical like the data record in FIG. 9 to a data store like a database, the common approach is to flatten it so it appears like the records in FIG. 8. This, however, often results in a data model in code that looks like the code in FIG. 10.

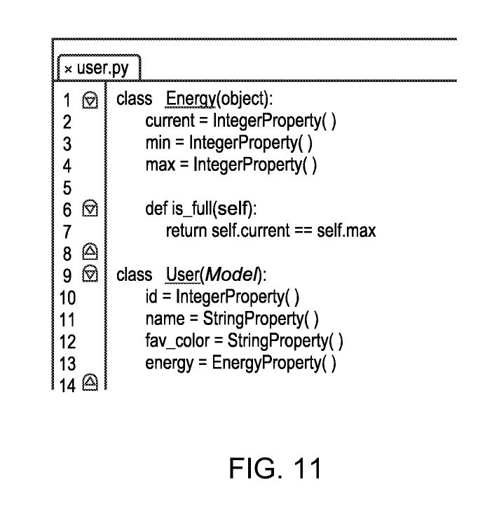

The code of FIG. 10, which maps to the flattened database schema of FIG. 8, results in a User class that has six attributes instead of four. While the code is functional, it is cumbersome (especially as more complex properties are added) and the energy properties and methods are not modularized in the typical object-oriented fashion. Furthermore, adding an energy property in another class or adding another property to the User model like energy would cause the developer to repeatedly copy and paste chunks of code into the various locations that it is needed, an approach that is often considered bad form. A more desirable approach to adding the energy property appears in FIG. 11.

In FIG. 11, Energy is a class unto itself that extends the Object class, and has current, min, and max as IntegerProperties. It also defines a function is_full, which returns a Boolean value (not expressly shown) indicating if the current energy is equal to the max energy. The User class then has an EnergyProperty for the attribute “energy.” This approach, though better than that of FIG. 10, is still not optimal.

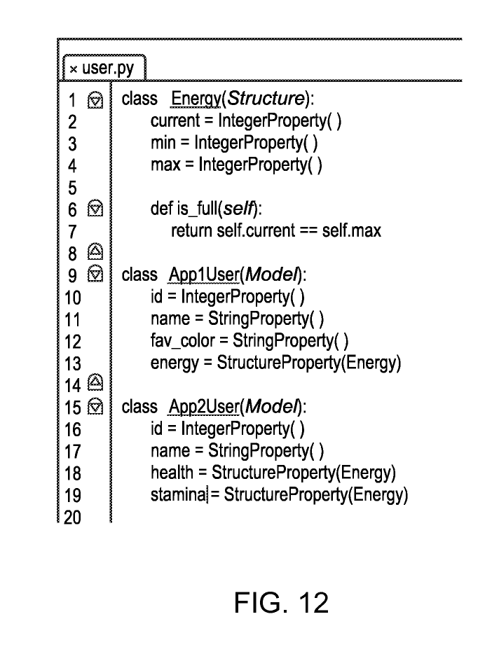

Instead, Catapult improves on this approach by providing a super-class of the Model class called a “Structure.” The structure supports the same Property semantics, and allows instances of the Structure class to themselves to be Property values. In FIG. 12, the Energy Structure being moved into its own class that extends Structure (rather than Object in FIG. 11), and is modular and re-usable across different models, e.g., App1User and App2User, and within the same model, e.g., health and stamina in App2User. The system naturally encompasses multiple hierarchy levels as well, since Structure instances are capable of having Structure properties themselves.

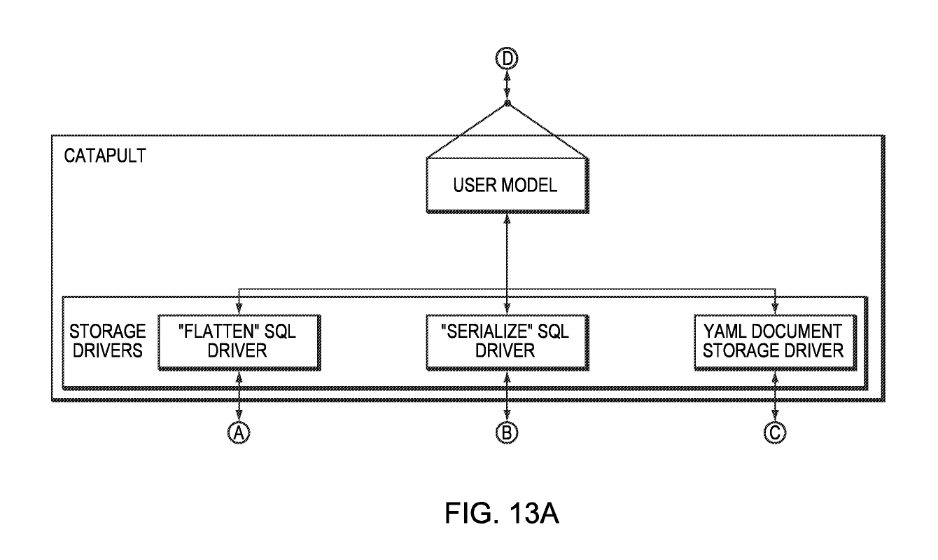

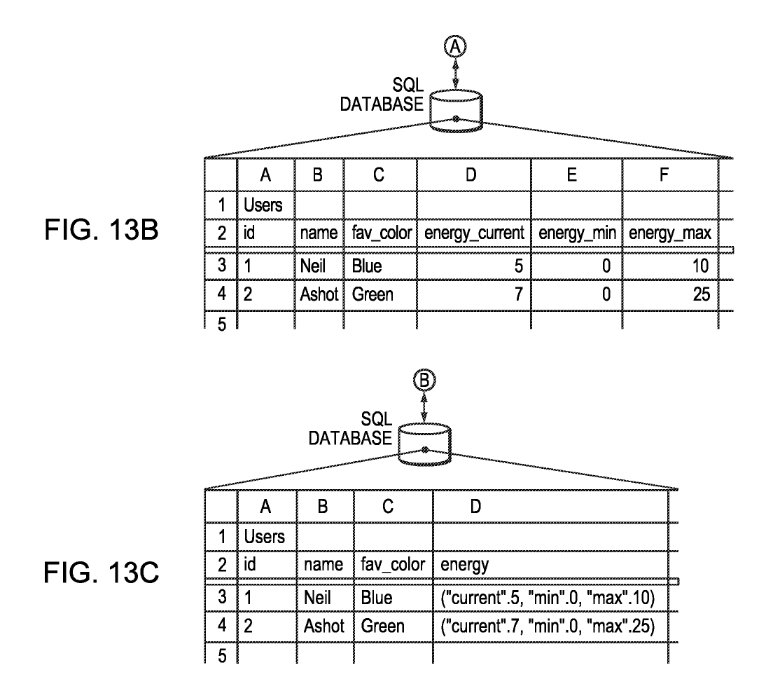

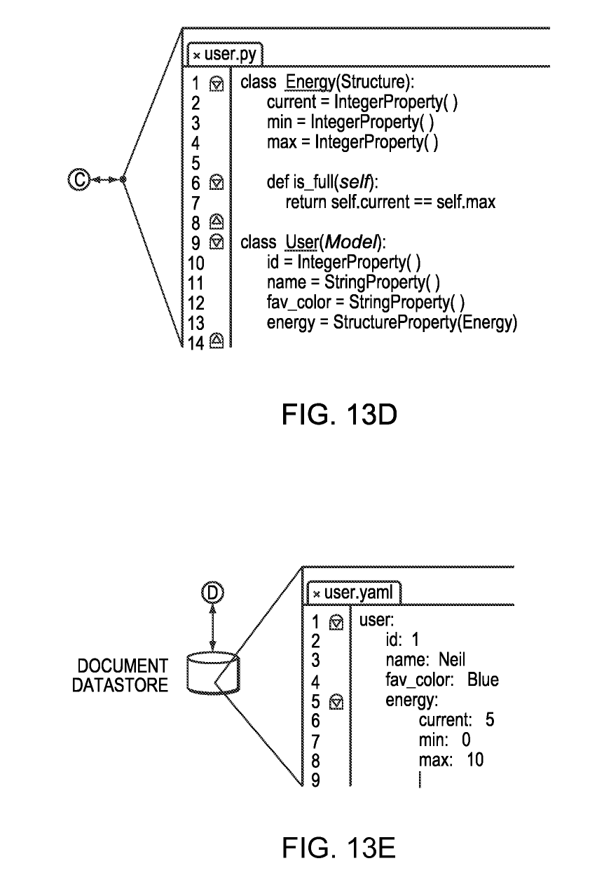

As shown in FIG. 13, the Catapult system avoids flattening the code to match the storage system (like in FIG. 10), and instead provides drivers for storage and transport that convert the Catapult complex and base types into formats usable by different storage and transport mechanisms. This lets application developers define their data in logical and modular object hierarchies without considering or committing to how the data records will be stored, and allows the application to define its data structures as best fit and leave storage decisions independent and interchangeable.

FIG. 13 shows the various drivers available to conform the User Model to the various data storage and transport mechanisms. In FIG. 13, the User model is ‘flattened’ by the Flattened SQL Driver to store the data in a format similar to that used in FIG. 8. A Serialize SQL Driver, however, stores the same data as id, name, fav_color, and a serialized version of the energy attribute. And, using the YAML data store format in FIG. 9, the attributes of the energy Property are stored in a way that conveys they are attributes of energy and not the user.

Beneficially, the same approach is also applied to moving Structure and Model instances across different transport protocols by passing the instances to different transport drivers instead of storage drivers.

As described above, each data store driver and transport driver in Catapult have established methods of storing and handling each of the base types when the instances are to be stored in the data store or transported. Each complex type attribute is declared as part of the Structure class declaration by attaching a Property instance as a class attribute. This Property instance is responsible for encoding complex values as base values for data storage and transport methods, and for decoding base values to complex values for use in the application. This is accomplished by Catapult “injecting” code into the creation process for that class. Specifically, as the class is being compiled, code is executed which inspects all the class attributes and creates a set of references to the Property instances, and attaches this set to the class. At this point, the code also copies the Property instance references from any parent classes so that standard class inheritance works as expected. Then, after compilation, the compiled Structure class has an attribute that is a set of all of its Property instances, each of which parameterizes a complex type. Then, when Catapult converts the Structure class to a series of base types, it iterates through this set and handles each complex type and its associated value individually. This class-level set of Property instances gives Catapult a well-defined schema for each Structure, which provides the functionality to express the complex types as base types.

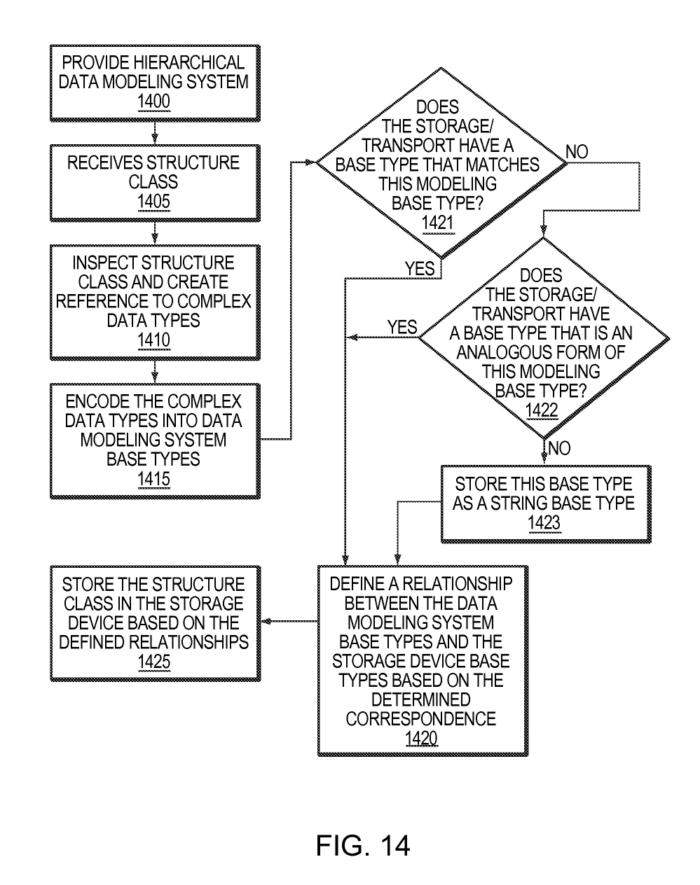

During transport and storage, as the schema is parsed, the drivers use the closest matching type that the storage or transport has available. For example, if the storage driver has an int type and the developer's class also has a variable that is an int type, the storage driver will use the int type to store the information held in the variable. If, however, there is not a strict correspondence between types, Catapult will use the most appropriate data storage or transport type for the given variable. For example, if the variable is an Integer (object), and the data storage type has an int type, Catapult will store the value of the Integer object using the int type. The correspondence can be established by referring to a set of known analogous relationships, e.g., storing the relationships in a lookup table. When no correspondence can be made by Catapult, it will store all values as strings, since most data store or transport mechanisms support a string data type. This allows developers store any complex type in any data store and move it across any transport without dependency on the application level. FIG. 14 depicts a flowchart for the process of converting complex types into base types in the context of the entire process.

In FIG. 14, the process begins by the Catapult system providing 1400 a hierarchical data modeling system to a computer program developer. The hierarchical data modeling system includes a number of data modeling system base data types and programming means to create one or more complex data types such as Model or Structure classes, with each complex data type being composed of the data modeling system base data types or other complex types. Then, a computer program language processor, e.g., a Python interpreter, compiler and/or runtime, receives 1405 a structure class comprising one or more complex data types from the developer. The computer program language processor then inspects 1410 the structure class during pre-processing (e.g., compilation, interpretation, or right before execution) and creates a reference to the one or more complex data types. Then, during execution of the class, the computer program language processor encodes 1415 the one or more complex data types of the structure class into a form expressed as the data modeling system base types. Then, a relationship is defined 1420 that maps the data modeling system base data types to the storage device base data types based on the correspondence described above. Specifically, it is determined 1421 if the modeling system has a base type with a direct correspondence to the base type of the storage driver, and if so, that mapping will be used. If, however, there is not a strict correspondence between types, Catapult will determine 1422 if there is an analogous base type that can be used. If so, that mapping will be used. If there is still no correspondence, Catapult will store 1423 all remaining values as strings. This series of mappings leads to the relationship defined 1420 between the data modeling system base types and the storage base types. With these relationships established, the structure class is stored 1425 in the storage device by storing the data modeling system base types of the encoded complex data type in the storage device using the defined relationships.

Though the computer program processor is used herein to describe performing all of the steps of receiving the structure class, compiling and inspecting it, encoding it, defining the relationships between the data modeling base types and those of the storage device, and storing of the structure class, it would understood by one of skill in the art that these can be separate processes, e.g., a text editor receives a structure class, a compiler compiles and inspects it, a runtime performs the encoding, etc., and that the term computer program processor is not to be limited to a single processor or process. Furthermore, any of these steps can be combined or performed in an order other than that listed.

Beneficially, the Structure's schema also provides other functionality as well. For example, a digital signature can be generated for each of the complex types on a Structure. The signatures for the complex types can then be combined into a digital signature for the Structure's current schema, which can then be added to saved records as a way of implementing non-linear schema versioning. This versioning would then allow data migration on a per-Structure basis.

The above-described techniques can be implemented in digital electronic circuitry, or in computer hardware, firmware, software, or in combinations of them. The implementation can be as a computer program product, i.e., a computer program tangibly embodied, e.g., in a non-transitory, machine-readable storage device for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, sub-routine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and an apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer also includes, or is operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

In some embodiments, execution of methods embodied as software limits the computers executing the software described herein to a particular purpose, e.g., providing the data model, inspecting the classes, encoding the complex types, and/or storing the data or other functionality described. In these scenarios, the computers, combined with the software, in effect, becomes a particular machine while the software is executing. In some embodiments, though other tasks may be performed while the software is running, execution of the software still limits the computers and may negatively impact performance of the other tasks. While the software is executing, the computer received classes, inspects them, creates references to its data types, and encodes the data in the complex types using the reference. Furthermore, the encoded complex types are stored using a data store's base types. This effectively transforms the complex types first into base types of the data model, and then again into base types of the data store.

To provide for interaction with a user or administrator, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. The alternatives described herein are examples for illustration only and not to limit the alternatives in any way. The steps of the invention can be performed in a different order and still achieve desirable results. Other embodiments are within the scope of the following claims.

What is claimed is:

1. A method for providing a flexible development platform comprising:
providing a hierarchical data modeling system to a computer program developer, the hierarchical data modeling system comprising a plurality of data modeling system base data types and programming means to create one or more complex data types, each complex data type comprising the data modeling system base data types or a first structure class;
receiving, by a computer program language processor, a second structure class comprising one or more complex data types;
inspecting the structure class, by a computer program language processor, during pre-processing and creating a reference to the one or more complex data types;
encoding, by the computer program language processor, the one or more complex data types of the second structure class using the reference into a form expressed as the data modeling system base types;
defining, by the programming language processor, a relationship between the plurality of data modeling system base data types and a plurality of storage device base data types; and
storing the first structure class in a storage device by storing the data modeling system base types of the encoded one or more complex data types in the storage device using the defined relationships.

2. A system for providing a flexible development platform comprising:
a hierarchical data modeling system comprising:
a plurality of data modeling system base data types;
a first structure class comprising one or more complex data types, each complex data type comprising the data modeling system base data types or a second structure class; and
an encoding module to convert the one or more complex data types of the first structure class into a form using only the data modeling system base types.

3. The system of claim 2 further comprising:
a first storage device comprising a first plurality of storage device base data types;
a first mapping that defines a relationship between the first plurality of storage device base data types and the plurality of data modeling system base data types; and
a first module for storing the first structure class to the first storage device by storing the data modeling system base types of the encoded complex data types in the first storage device using the first plurality of storage device base data types based on the first mapping.

4. The system of claim 3, wherein:
the first storage device can be replaced with a second storage device with a second plurality of storage device base types;
the first mapping can be replaced with a second mapping that defines a relationship between the second plurality of storage device base data types and the plurality of data modeling system base data types; and
the first module can be replaced by a second module for persisting the first structure class to the second storage device by storing the data modeling system base types of the encoded complex data types in the second storage device using the second plurality of storage device base data types based on the second mapping; and
wherein replacing the first storage device and the first module with the second storage device and second module do not alter the structure class.

5. The system of claim 3, wherein the storage device is a database.

6. The system of claim 3, wherein the storage device is a document datastore.

7. The system of claim 2, further comprising a framework configured to allow a developer to define the first structure class and the one or more complex data types, but not define the plurality of data modeling system base data types.

8. A computer program product, tangibly embodied in a non-transient computer-readable storage medium, for providing a flexible development platform, the computer program product including instructions operable to cause a data processing apparatus to:
provide a hierarchical data modeling system comprising:
a plurality of data modeling system base data types;
a first structure class comprising one or more complex data types, each complex data type comprising the data modeling system base data types or a second structure class; and
provide an encoding module to convert the one or more complex data types of the first structure class into a form using only the data modeling system base types.

9. The computer program product of claim 8 comprising instructions further operable to cause the data processing apparatus to:
provide a first mapping that defines a relationship between a first plurality of storage device base data types of a first storage device and the plurality of data modeling system base data types; and
provide a first module for storing the first structure class to the first storage device by storing the data modeling system base types of the encoded complex data types in the first storage device using the first plurality of storage device base data types based on the first mapping.

10. The computer program product of claim 9, wherein:
the first storage device can be replaced with a second storage device with a second plurality of storage device base types;
the first mapping can be replaced with a second mapping that defines a relationship between the second plurality of storage device base data types and the plurality of data modeling system base data types; and
the first module can be replaced by a second module for persisting the first structure class to the second storage device by storing the data modeling system base types of the encoded complex data types in the second storage device using the second plurality of storage device base data types based on the second mapping; and
wherein replacing the first storage device and the first module with the second storage device and second module do not alter the structure class.

11. The computer program product of claim 9, wherein the storage device is a database.

12. The computer program product of claim 9, wherein the storage device is a document datastore.

13. The computer program product of claim 8 comprising instructions further operable to cause the data processing apparatus to provide a framework configured to allow a developer to define the first structure class and the one or more complex data types, but not define the plurality of data modeling system base data types.

14. A method for providing a flexible development platform comprising:
providing a hierarchical data modeling system comprising:
a plurality of data modeling system base data types;
a first structure class comprising one or more complex data types, each complex data type comprising the data modeling system base data types or a second structure class; and
providing an encoding module to convert the one or more complex data types of the first structure class into a form using only the data modeling system base types.

15. The method of claim 14, further comprising:
a first storage device comprising a first plurality of storage device base data types;
a first mapping that defines a relationship between the first plurality of storage device base data types and the plurality of data modeling system base data types; and
a first module for storing the first structure class to the first storage device by storing the data modeling system base types of the encoded complex data types in the first storage device using the first plurality of storage device base data types based on the first mapping.

16. The method of claim 15, wherein:
the first storage device can be replaced with a second storage device with a second plurality of storage device base types;
the first mapping can be replaced with a second mapping that defines a relationship between the second plurality of storage device base data types and the plurality of data modeling system base data types; and
the first module can be replaced by a second module for persisting the first structure class to the second storage device by storing the data modeling system base types of the encoded complex data types in the second storage device using the second plurality of storage device base data types based on the second mapping; and
wherein replacing the first storage device and the first module with the second storage device and second module do not alter the structure class.

17. The method of claim 15, wherein the storage device is a database.

18. The method of claim 15, wherein the storage device is a document datastore.

19. The method of claim 14, further comprising a framework configured to allow a developer to define the first structure class and the one or more complex data types, but not define the plurality of data modeling system base data types.
